(19) United States
(12) Patent Application Publication
(10) Pub. No.: US 2010/0277603 A1
(43) Pub. Date: Nov. 4, 2010

(54) Image Capture Device to Minimize the Effect of Device Movement

(75) Inventor: Richard Tsai, Cupertino, CA (US)

Correspondence Address: APPLE INC./BSTZ;BLAKELY SOKOLOFF TAYLOR & ZAFMAN LLP, 1279 OAKMEAD PARKWAY, SUITE 300, SUNNYVALE, CA, 94085-4040, US

(73) Assignee: Apple Inc., Cupertino, CA (US)

(21) Appl. No.: 12/432,623

(22) Filed: Apr. 29, 2009

(51) Int. Cl. H04N 5/228

(52) U.S. Cl. 348/208.4; 348/E05.031

(57) ABSTRACT

A device to capture an image includes an image sensor on which an optical image is formed by a lens. The image sensor provides electrical signals that represent the optical image. A motion sensor is included to sense movement of the image sensor. An image processor is coupled to the image sensor and the motion sensor. The image processor adjusts an integration time of the image sensor responsive to the motion sensor and creates a digital image according to the electrical signals received from the image sensor. The image processor may further respond to a signal-to-noise ratio in the electrical signals when adjusting the integration time. The image processor may select a frame scan of the image sensor responsive to the motion sensor. The image processor may add movement metadata to the digital image.

### BACKGROUND

1. Field

Embodiments of the invention relate to the field of digital imaging; and more specifically, to stabilizing captured images.

2. Background

A camera captures an image by recording the light reflected from a subject. It is necessary for the camera to be relatively still during the time the image is being recorded to provide a sharp image. A camera may use an electronic image sensor, such as a charge coupled device (CCD) or complementary metal oxide semiconductor (CMOS) sensor, to record images. The electronic image sensor converts light that falls on area of the sensor into an electrical charge that is proportional to the amount of light received. The electronic image sensor may include a large number of separated areas arranged in a pattern over the image sensor. The areas represent pixels of an image.

A lens may focus an optical image on the electronic image sensor. The electronic image sensor converts the light from the optical image into a pattern of charges on the image sensor. These charges may be read in the form of electrical signals that can be converted into digital representations of the light intensity for each pixel of the image sensor.

It is necessary that the image be maintained on the image sensor for a period of time to allow a sufficient number of photons to be captured and converted into an electrical charge to produce a high-quality image. The period of time during which a charge is accumulated from an optical image may be termed “integration time.” The integration time is the amount of time a pixel on the image sensor is set to collect an electrical charge generated from light falling on the pixel.

Electronic image sensors may produce an “image” even when no light falls on the sensor. This “image” represents noise produced by the sensor. There may be other forms of noise produced by the sensor as well. It is desirable that the optical image produce signals that are substantially greater than the noise signals. Increasing the amount of light that is converted into electrical charges by the image sensor by increasing the integration time will improve the ratio of signal produced by the optical image to signal produced as noise, the signal to noise ratio (SNR), thus improving the quality of the captured digital image.

While increasing the integration time improves the SNR, it also increases susceptibility to motion blurring of the captured image. An increased integration time of the electronic image sensor has the same effect as a slow shutter speed in a conventional film camera. Movement of the optical image on the image sensor during the integration time creates a blurry image. Movement of the optical image may be the result of either movement of the subject being photographed or movement of the camera while the pictures being taken.

A certain amount of movement of the camera is inevitable when a camera is handheld. Healthy people exhibit rhythmic oscillations in body position and muscle contraction, and these oscillations are called physiologic tremor. Physiologic hand tremor in a resting hand may have a frequency of approximately 8 to 12 Hz and an amplitude of approximately 0.1 of a millimeter. Stress and fatigue from holding a camera may increase the amplitude of hand tremor and somewhat alter the frequency. Camera motion may also result from other sources such as vibration of a moving vehicle that carries the camera. Movement of the camera during the integration time will result in a blurry image which is generally undesirable. Thus a trade-off must be made between a longer integration time to reduce SNR and a shorter integration time to reduce motion blurring.

Some cameras employ optical image stabilization to reduce movement of the optical image on the image sensor that would otherwise result from movement of the camera. Optical image stabilization involves moving some portion of the optical path such as a lens element or the image sensor to reduce the motion of the optical image on the image sensor. Optical image stabilization allows a longer integration time to be used because the camera is less susceptible to movement of the optical image on the image sensor. However optical image stabilization adds a substantial cost to the camera.

Cameras with digital image sensors are increasingly being added to various mobile devices, such as mobile telephones, personal digital assistants (PDA), mobile computers, and the like. When a camera is added to a mobile device that provides functions in addition to capturing images, the image capture may be a secondary function. As such, it is desirable to minimize the cost required to provide the image capture function. It would be desirable to provide features that reduce motion blurring due to camera movement without unnecessarily increasing the SNR of captured images or adding substantial cost to the mobile device.

### SUMMARY

A device to capture an image includes an image sensor on which an optical image is formed by a lens. The image sensor provides electrical signals that represent the optical image. A motion sensor is included to sense movement of the image sensor. An image processor is coupled to the image sensor and the motion sensor. The image processor adjusts an integration time of the image sensor responsive to the motion sensor and creates a digital image according to the electrical signals received from the image sensor. The image processor may further respond to a signal-to-noise ratio in the electrical signals when adjusting the integration time. The image processor may select a frame scan of the image sensor responsive to the motion sensor. The image processor may add movement metadata to the digital image.

Other features and advantages of the present invention will be apparent from the accompanying drawings and from the detailed description that follows below.

### BRIEF DESCRIPTION OF THE DRAWINGS

The invention may best be understood by referring to the following description and accompanying drawings that are used to illustrate embodiments of the invention by way of example and not limitation. In the drawings, in which like reference numerals indicate similar elements:

FIG. 1 is a simplified block diagram of a device to capture a digital image.

FIG. 2 is a graph of an exemplary motion of an image sensor over time.

FIG. 3 is a graph of another exemplary motion of an image sensor over time.

FIG. 4 is a graph of a shutter release delay time to place the integration time interval at a time with small image sensor motion.

FIG. 5 is a graph of another shutter release delay time to place the integration time interval at the time with small image sensor motion.

FIG. 6 is a flowchart of a method for capturing a digital image.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

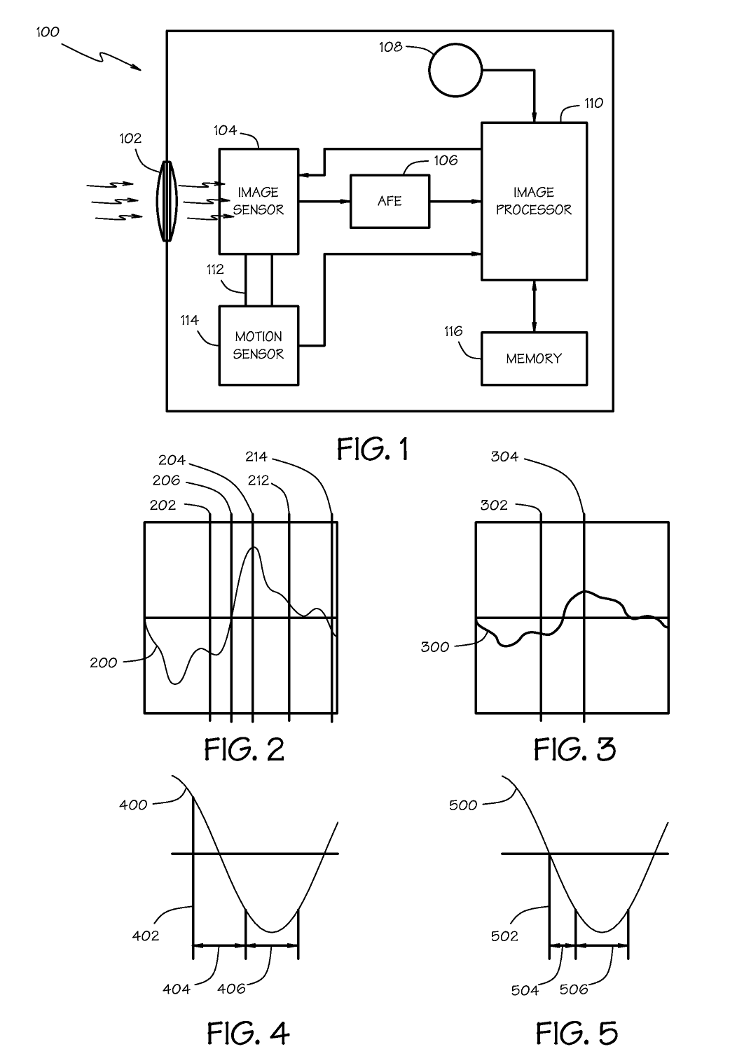

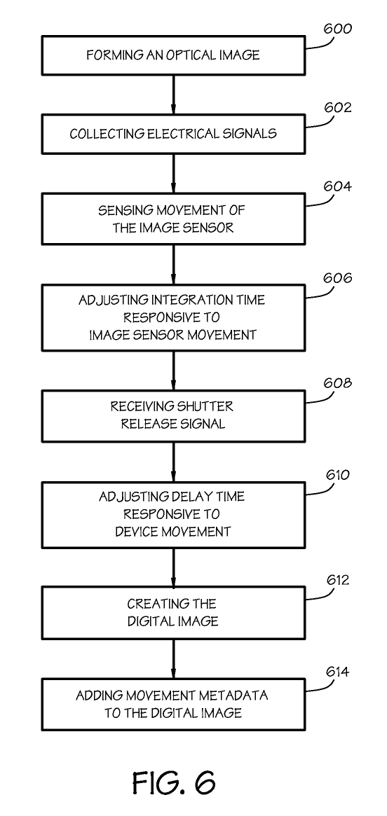

FIG. 1 is a simplified block diagram of a device 100 to capture a digital image. The device may be a digital camera or a mobile multifunction device such as a cellular telephone, a personal digital assistant, or a mobile entertainment device. Many aspects of the device, such as power supply, visual display, strobe light, autofocus and zoom mechanisms, and other aspects that are not immediately relevant to the instant invention have been omitted to avoid obscuring the relevant aspects of the device.

The device 100 includes an image sensor 104 on which an optical image is formed by a lens 102. The image sensor 104 collects electrical signals during an integration time and provides the electrical signals to an image processor 110 as a representation of the optical image formed by the light falling on the image sensor. An analog front end (AFE) 106 may process the electrical signals provided by the image sensor 104 before they are provided to the image processor 110. The integration time of the image sensor can be adjusted by the image processor 110.

The device 100 includes a motion sensor 114 that senses movement of the image sensor 104. The motion sensor 114 is mechanically fixed such that there is no relative movement between the motion sensor and the image sensor 104 as suggest by the mechanical link 112 shown connecting the sensors. The mechanical link 112 between the motion sensor 114 and the image sensor 104 may be provided by a housing of the device 100 to which both sensors are mounted. In some embodiments the motion sensor 114 may be an accelerometer. In other embodiments the motion sensor 114 may be an inertial sensor, such as a gyroscopic type sensor.

The motion sensor 114 is coupled to the image processor 110. The image processor adjusts the integration time of the image sensor 104 responsive to the motion sensor 114. The image processor 110 may use other inputs to determine the integration time of the image sensor 104 in addition to the input from the motion sensor 114. For example, the image processor 110 may use the signal to noise ratio (SNR) in the electrical signals received from the image sensor 104 in conjunction with the input from the motion sensor 114 to determine the integration time.

FIG. 2 shows a graph of an exemplary motion 200 of the image sensor over time. As suggested by the graph, the motion may be oscillatory, such as motion induced by a physiologic hand tremor. If the device is handheld the device motion may be relatively large and fast. During the image sensor's 104 integration time interval, which may be represented by the interval between the vertical lines 202, 204, the sensor may move through a large displacement as suggested by the vertical distance between the minima and maxima of the displacement curve 200 during the integration time interval. This will produce significant blurring in the captured image.

FIG. 3 shows a graph of another exemplary motion 300 of the image sensor over time when the device motion has been minimized, such as by placing the camera on a stable platform like a tripod, a solid stable object, or even by hand holding techniques that allow the device to be held in a manner that is more stable. During the image sensor's 104 integration time interval, which may be represented by the interval between the vertical lines 302, 304, the sensor may move through a smaller displacement as suggested by the vertical distance between the minima and maxima of the displacement curve 300 during the integration time interval. This will produce less blurring in the captured image than in the handheld configuration represented by FIG. 2.

The amount of blurring when the camera is subject to large, rapid displacements as shown in FIG. 2 can be reduced by shortening the integration time, as suggested by the interval between the closer vertical lines 202, 206. However, shortening the integration time will increase the SNR in the captured image. When the motion sensor 114 indicates that the image sensor 104 is relatively still, the image processor 110 may increase the integration time more in response to a high SNR than it would if the motion sensor 114 indicates that the image sensor 104 is less still. Thus the image processor 110 may allow a higher SNR in the captured image when necessary to reduce motion blurring as indicated by the motion sensor 114 while using longer integration times to achieve a lower SNR wherein the motion sensor indicates that the image sensor is relatively still.

It will be appreciated that even when the device is subject to large, rapid displacements as shown in FIG. 2, there may be integration time intervals, such as the interval represented by the rightmost vertical lines 212, 214, during which the sensor moves through a small displacement because the integration time interval occurs when the device is relatively quiescent, such as at an extremis of displacement where the direction of motion is changing. Thus the image processor 110 may use the input from the motion sensor 114 to provide a predicted or expected value for the amount of displacement that might occur during a particular integration time interval. This may be used to generate a “blurriness factor” that can be compared to the SNR that results from the particular integration time interval. The image processor 110 may attempt to optimize the integration time interval to balance the resulting SNR against an expected level of blurriness.

The image processor 110 creates a digital image according to the electrical signals received from the image sensor 104, which may be stored in a memory 116. The memory may be a fixed or a removable memory or it may include both fixed and removable portions. A portion of the memory may be a read-only memory that provides instructions that are executed by the image processor to perform some or all of the functions provided by the image processor.

The image processor 110 may create the digital image in response to a shutter release signal received from a shutter release device 108 such as a button pressed by a user. The image use the input from the motion sensor 114 to detect a motion of the image sensor 104, such as a physiologic tremor, and predict times of minimum movement. The image processor 110 may cause the image sensor 104 to collect electrical signals after a delay time that is adjusted responsive to the movement of the device such that the image is sensed during a time period when the image sensor is predicted to be relatively still.

FIG. 4 shows a graph of an exemplary motion 400 of the image sensor over time. The leftmost vertical line 402 represents a time when a shutter release signal is received. The shutter release signal may initiate the start of a frame capture. The next two vertical lines to the right indicate a start and an end of an integration time 406 during which the image is sensed. The distance 404 between the time when the shutter release signal is received and the start of the integration time 406 period is the delay time as adjusted by the image processor 110. It will be noted that the delay time 404 has been adjusted such that the integration time 406 occurs during a time when the amplitude of movement of the image sensor is relatively small.

FIG. 5 shows a graph of the exemplary motion 500 of the image sensor with a different time when the shutter release signal is received. As suggested by the group of three vertical lines, if the shutter release signal 502 is received at a later time with respect to the periodic motion, the delay time 504 may be shorter so that the integration time 506 still occurs during a time when the amplitude of movement is relatively small. While a periodic motion has been illustrated for clarity, the motion may not be periodic. The image processor may use various techniques to predict the relatively small movements of the image sensor when the motion is not periodic such as analyzing the velocity and acceleration of the image sensor.

The image processor may add movement metadata to the digital image according to input from the motion sensor during the integration interval when the digital image was created, which may then be stored in a memory 116. The added movement metadata may permit later processing of the image based on the amount of movement of the image sensor when the image was captured. For example, the movement metadata may allow selection of “better” images from a series of images captured during a burst mode exposure in which a number of images are captured in rapid succession. As another example, the movement metadata may allow image processing to reduce the apparent blur caused by image sensor motion while the image was being captured.

FIG. 66 is a flowchart of a method for capturing a digital image. An optical image is formed on an image sensor 600. Electrical signals that represent the optical image are collected from the image sensor 602 during an integration time. Movement of the image sensor is sensed 604. The movement of the image sensor may be sensed with an accelerometer that is mechanically fixed such that there is no relative movement between the accelerometer mounting and the image sensor. In another embodiment, movement of the image sensor may be sensed with an inertial sensor that is mechanically fixed such that there is no relative movement between the inertial sensor mounting and the image sensor. The inertial sensor may be a gyroscopic type sensor.

The integration time of the image sensor is adjusted responsive to the movement of the image sensor 606. If there is a large amount of movement of the image sensor, then the integration time of the image sensor is reduced to lessen the blurring caused by the movement. Conversely, if there is a small amount of movement of the image sensor, the integration time of the image sensor can be increased to improve the SNR. In some embodiments, the SNR is also used in selecting the integration time. Thus the integration time of the image sensor may not be reduced as much in response to a large amount of movement of the image sensor if the SNR is low. Similarly, the integration time of the image sensor may not be increased as much in response to a small amount movement of the image sensor if the SNR is high. The digital image is then created according to the electrical signals from the image sensor 612.

In some embodiments, the method further includes receiving a shutter release signal 608 to indicate that the digital image should be created and adjusting a delay time 610 between receiving the shutter release signal and collecting electrical signals in the image sensor, the delay time being adjusted responsive to the movement of the device.

In some embodiments, the method of creating the digital image further includes adding movement metadata 614 to the digital image according to the movement of the device when creating the digital image.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other modifications may occur to those of ordinary skill in the art. The description is thus to be regarded as illustrative instead of limiting.

What is claimed is:

1. A device to capture a digital image, the device comprising:
an image sensor on which an optical image is formed by a lens, the image sensor collecting electrical signals during an integration time and providing the electrical signals as a representation of the optical image;
a motion sensor that senses movement of the image sensor; and
an image processor coupled to the image sensor and the motion sensor, the image processor to adjust an integration time of the image sensor responsive to the motion sensor and to create the digital image according to the electrical signals received from the image sensor.

2. The device of claim 1, wherein the motion sensor is an accelerometer that is mechanically fixed such that there is no relative movement between the accelerometer and the image sensor.

3. The device of claim 1, wherein the motion sensor is an inertial sensor that is mechanically fixed such that there is no relative movement between the inertial sensor and the image sensor.

4. The device of claim 3, wherein the motion sensor is a gyroscopic type sensor.

5. The device of claim 1, wherein the image processor adjusts the integration time of the image sensor responsive further to a signal to noise ratio in the electrical signals received from the image sensor.

6. The device of claim 1, wherein the image processor creates the digital image in response to a shutter release signal, the image processor causing the image sensor to collect electrical signals after a delay time that is adjusted responsive to the movement of the device.

7. The device of claim 1, wherein the image processor adds movement metadata to the digital image according to input from the motion sensor when the digital image was created.

8. A method for capturing a digital image, the method comprising:
forming an optical image on an image sensor;
collecting electrical signals in the image sensor during an integration time, the electrical signals representing the optical image;
sensing movement of the image sensor;
adjusting the integration time of the image sensor responsive to the movement of the image sensor; and
creating the digital image according to the electrical signals from the image sensor.

9. The method of claim 8, wherein movement of the image sensor is sensed with an accelerometer that is mechanically fixed such that there is no relative movement between the accelerometer and the image sensor.

10. The method of claim 8, wherein movement of the image sensor is sensed with an inertial sensor that is mechanically fixed such that there is no relative movement between the inertial sensor and the image sensor.

11. The method of claim 10, wherein the inertial sensor is a gyroscopic type sensor.

12. The method of claim 8, wherein adjusting the integration time is further responsive to a signal to noise ratio in the electrical signals from the image sensor.

13. The method of claim 8, wherein creating the digital image further includes:
receiving a shutter release signal; and
adjusting a delay time between receiving the shutter release signal and collecting electrical signals in the image sensor, the delay time being adjusted responsive to the movement of the device.

14. The method of claim 8, further comprising adding movement metadata to the digital image according to the movement of the device when the digital image was created.

15. A device to capture a digital image, the device comprising:
means for forming an optical image;
means for collecting electrical signals in the image sensor during an integration time, the electrical signals representing the optical image;
means for sensing movement of the image sensor;
means for adjusting the integration time of the image sensor responsive to the movement of the image sensor; and
means for creating the digital image according to the electrical signals from the means for forming the optical image.

16. The device of claim 15, wherein the means for sensing movement of the device is an accelerometer that is mechanically fixed to the device such that there is no relative movement between the accelerometer and the means for forming the optical image.

17. The device of claim 15, wherein the means for sensing movement of the device is an inertial sensor that is mechanically supported by the device such that there is no relative movement between the inertial sensor and the means for forming the optical image.

18. The device of claim 17, wherein the inertial sensor is a gyroscopic type sensor.

19. The device of claim 15, wherein the means for adjusting the integration time is further responsive to a signal to noise ratio in the electrical signals from the means for forming the optical image.

20. The device of claim 15, wherein the device further includes:
means for receiving a shutter release signal; and
means for adjusting a delay time between receiving the shutter release signal and collecting electrical signals in the image sensor, the delay time being adjusted responsive to the movement of the device.

21. The device of claim 15, further comprising means for adding movement metadata to the digital image according to the movement of the device when the digital image was created.
